(19) United States
(12) Patent Application Publication
(10) Pub. No.: US 2022/0291124 A1
(43) Pub. Date: Sep. 15, 2022

(54) NONINVASIVE VACCINE TESTER

(71) Applicant: HANNU HARJUNMAA, HOLDEN, MA (US)

(72) Inventor: HANNU HARJUNMAA, HOLDEN, MA (US)

(21) Appl. No.: 17/707,936

(22) Filed: Mar. 29, 2022

Related U.S. Application Data
(60) Provisional application No. 63/167,623, filed on Mar. 29, 2021.

(51) Int. Cl. G01N 21/43; G01N 21/41

(52) U.S. Cl. CPC G01N 21/431; G01N 21/4133

(57) ABSTRACT

This invention this invention is a device and method for validating the identity of a liquid in a container that is transparent to light, while the liquid is in the container, without physically invading container. The liquid is particularly suited for validating vaccines such as the vaccine for COVID-19. The invention uses light from a refractometer and/or nephelometer, passing into and reflected out of the transparent wall of the container, to characterize the liquid.

### BACKGROUND OF THE INVENTION

The present invention is in the technical field of testing of liquids. More particularly, the present invention is in the technical field of validating the identity of liquids, such as vaccines.

### BACKGROUND OF THE INVENTION

The Problem Addressed. Diseases have been the bane of humanity throughout recorded history and probably before recorded history. As human understanding of diseases and their causes has increased, various methods for reducing the negative impact of diseases, and, in some cases, even eliminating the diseases, have been developed. One of the most dramatic such scientific breakthroughs is the development of vaccines for preventing or reducing the damage caused by the diseases and in particular the virally caused diseases. And perhaps the most dramatic of all these scientific breakthroughs is the amazingly rapid development of vaccines against the COVID-19.

These vaccines are being manufactured in many industrialized nations and transported all over the world to be administered to potential patients. Because of the very high cost of developing and manufacturing the vaccines, the vaccines are very expensive and are often in short supply especially in less developed nations. As a result, a significant criminal activity in producing and distributing counterfeit and noneffective products that masquerade as vaccines has arisen. Potential for patients believing that they are properly vaccinated when in fact they have been administered nonfunctioning counterfeit products is a real risk not only to the individuals went to the nations who are trying to plan for management of the pandemic.

The problem of non-functioning counterfeit vaccines is very real. COVID-19 vaccine forgeries have been detected in 50 cases in 16 countries (March 2021). Millions of people are exposed to the risk of getting a non-effective or even harmful counterfeit vaccine and ending without protection against COVID-19, or worse, There is no simple method to test a vaccine immediately before use.

### SUMMARY OF THE INVENTION

This invention this invention is a device and method for validating the identity of a liquid in a container that is transparent to light, while the liquid is in the container, without physically invading container. The liquid is particularly suited for validating vaccines such as the vaccine for COVID-19. The invention uses light from a refractometer and/or nephelometer, passing into and reflected out of the transparent wall of the container, to characterize the liquid.

The method begins by using the tester device to determine the optical characteristics of a standard sample of known validity. Then the containers of liquid to be placed in the testing device and the optical characteristics of the sample to be tested are compared to the standard optical characteristics. Because the method only enters the container with light, through the transparent wall of the container, there is no physical invasion of the samples in the samples can remain sealed because the validation is essentially instantaneous, it can be done immediately before use of the liquid, such as injection into a patient of a vaccine.

### BRIEF DESCRIPTION OF THE DRAWINGS

FIG. 1 is a perspective view of a noninvasive optical testing device, without the test sample inserted, embodying the principles of the present invention;

FIG. 2 is a perspective view of a noninvasive optical testing device, with the test sample inserted, embodying the principles of the present invention;

FIG. 3 is a plan view of a noninvasive optical testing device, with the test sample inserted, but without an optional cover, which keeps light out of the sample holder; embodying the principles of the present invention;

FIG. 4 is a plan view of a noninvasive optical testing device, with the test sample inserted, but hidden, and with an optional cover, which keeps light out of the sample holder; embodying the principles of the present invention;

FIG. 5 is a sectional front elevation view of a noninvasive optical testing device, with the test sample inserted, and with an optional cover which keeps light out of the sample holder; embodying the principles of the present invention.

### DETAILED DESCRIPTION OF THE INVENTION

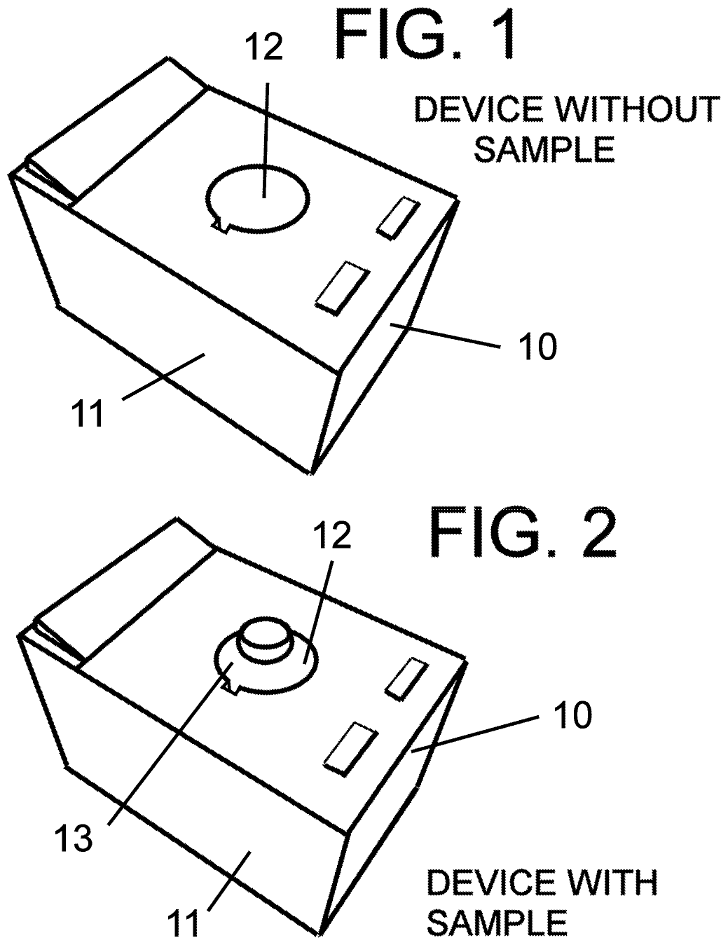

Referring now to the invention in more detail, in FIG. 1 there is shown a perspective view of a noninvasive optical testing device, without the test sample inserted. The device 10 is shown to include a box 11. The box 11 includes a display screen and buttons for controlling the operation of the device 10. The box 11 has a sample compartment 12 that opens at the top of the box 11, that allows a bottle to be inserted into the box 11.

FIG. 2 is a perspective view of a noninvasive optical testing device, with the test sample inserted. The device 10 is shown to include a box 11. The box 11 includes a display screen and buttons for controlling the operation of the device 10. The box 11 has a sample compartment 12 that opens at the top of the box 11, that allows a bottle 12 to be inserted into the box 11.

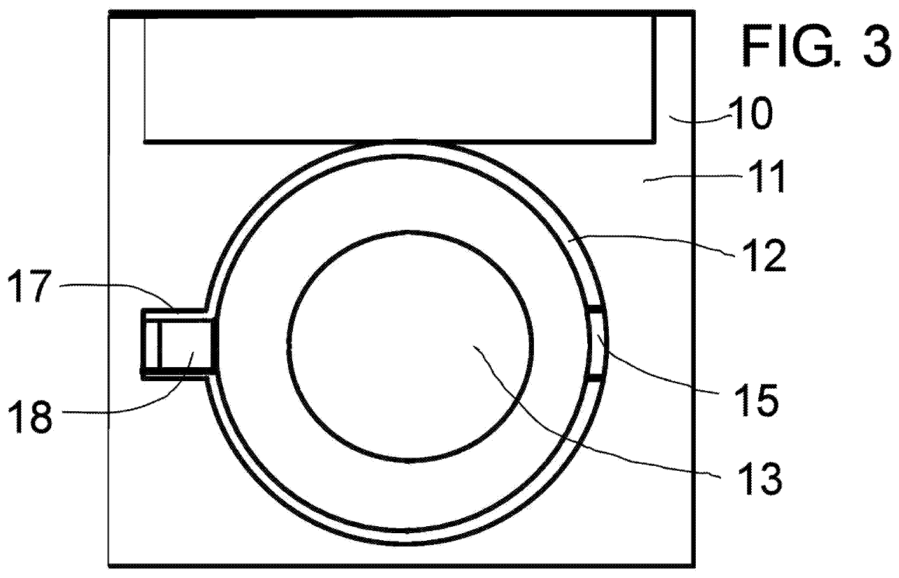

FIG. 3 is a plan view of a noninvasive optical testing device, with the test sample inserted, but without an optional cover, which keeps light out of the sample holder. The device 10 is shown to include a box 11. The box 11 has a sample compartment 12 that opens at the top of the box 11, that allows a bottle 12 to be inserted into the box 11. The upper sensor 15 is partially shown between the sample bottle 15 and the wall of the sample compartment 12. On the left side, a spring compartment 17 opens into the sample compartment 12 and holds a spring 18 that presses the sample bottle against the upper sensor 15, and the lower sensor 16 (not shown here). Thus, when the sample bottle 15 is pushed down into the sample compartment 12, the spring 18 holds the sample bottle 15 firmly against the upper 15 and lower sensor 16.

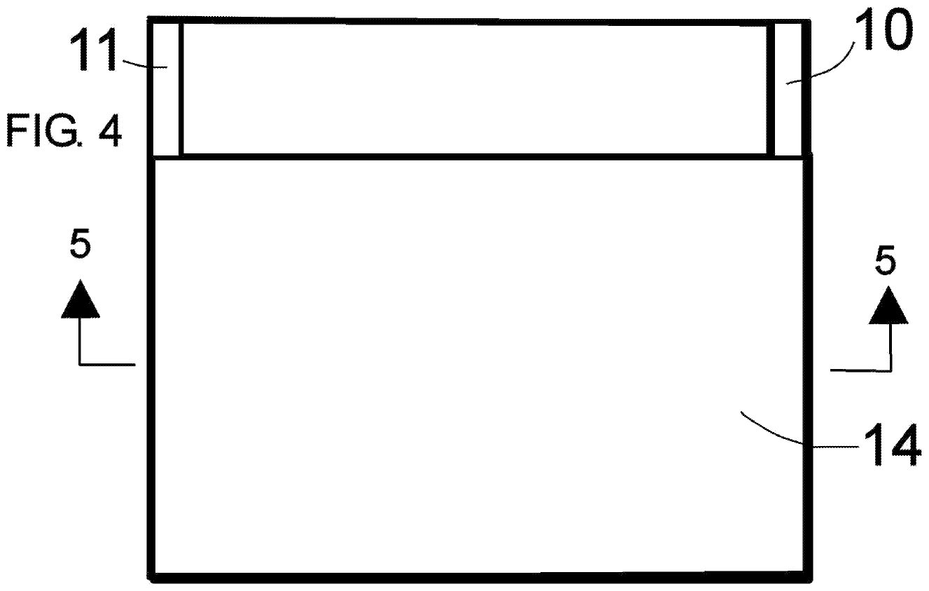

FIG. 4 is a plan view of a noninvasive optical testing device 10, with the test sample inserted, but hidden, and with an optional cover 14, which keeps light out of the sample holder 12 (not shown here).

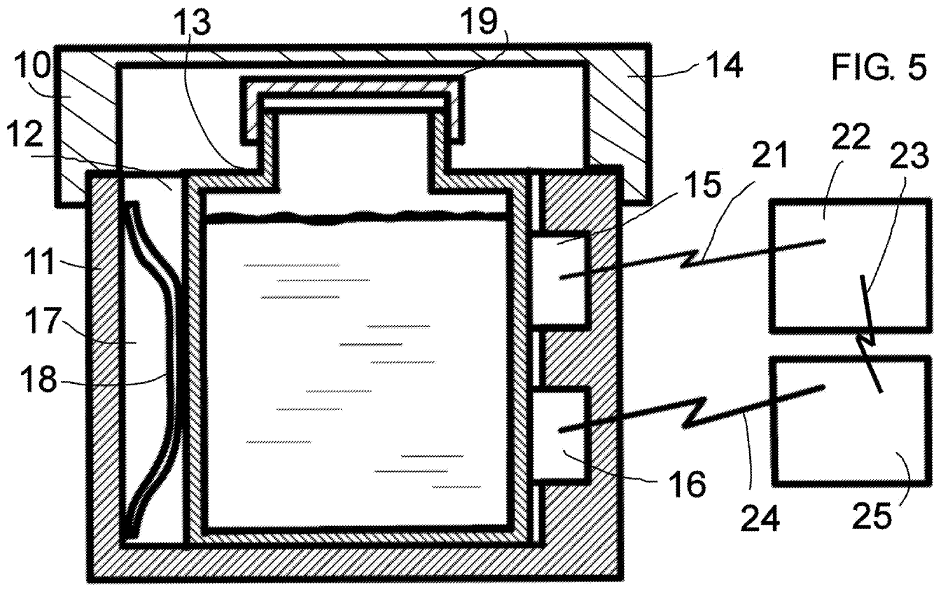

FIG. 5 is a sectional front elevation view, taken along line 5-5, of FIG. 4, of a noninvasive optical testing device 10, with the test sample 13, having a sealed cap 19, inserted into the sample holder 12, and with an optional cover 14 which keeps light out of the sample holder. The spring 18 in the spring pocket 17 presses the test sample 13 against the upper sensor 15 and the lower sensor 16 in order to get the most effective transmission of light from each sensor into the sample 13. The upper sensor 15 is connected through a communication link 21 with a data processor 22. Lower sensor 16 is connected through a communication link 24 to a data processor 25. Data processor 22 and data processor 25 are connected by means of a communication link 23. This allows the system to harvest the data from each of the upper sensor 15 and the lower sensor 16, and process that data against the standard data which determines whether the sample being tested is a valid sample. In the preferred embodiment, the upper sensor 15 would be a refractometer as described in U.S. Pat. No. 10,139,340, and the lower sensor 16 would be a nephelometer as described in U.S. Pat. No. 10,234,386.

The preferred version of this device is a combined refractometer and nephelometer. A refractometer is an instrument for the measurement of an index of refraction of a liquid. A nephelometer is an instrument for measuring the concentration of suspended particulates in a liquid. The refractometer and the nephelometer that are preferred for use in this invention have been granted separate US patents (U.S. Pat. Nos. 10,139,340 and 10,234,386, respectively). Although each of these devices can non-invasively characterize a liquid in a transparent container, the combination provides an exceptional level of identification, because each device relies of different characteristics of a liquid.

The device is a box with a hole on top where the vial is inserted. There is a display and the necessary number of push buttons (probably two). Inside the box there are two printed circuit boards: the motherboard and the display/push button board. The boards are connected with a flex cable. Manual assembly is minimized by having all electronic components sit on the boards, thus allowing robotic assembly. The laser may need manual mounting. There are no moving parts.

The measurements will be carried out at room temperature. Some vaccines are diluted for injection; some are not. The intention is to measure vials unopened, before dilution. That will also make the measurement easier as the concentrations are higher.

Optical Design: The optical design of the preferred version of this invention follows the teachings of the two US patents, mentioned above. The dimensions of the this device will be effected by the dimensions of the vaccine vials.

The optical assembly sits on a motherboard. The vial is in direct contact with the optical assembly, subjected to a light lateral pressure effected by a spring assembly to ensure good contact. The optics consist of one (525 nm) diode laser (modulated to minimize the effect of ambient light), one optical assembly part consisting of four light pipes (injection molded), and four detectors that sit on the motherboard. The laser is probably best mounted manually into the optical assembly. Being seated in the optical assembly, its alignment is secure. Detectors (1 and 2) perform the refractometer function, and detectors (3 and 4) perform the nephelometer function. Both measurements are ratiometric. The refractometer data is distorted by scattered light from the vaccine if the vaccine is cloudy; the nephelometer data is used to correct it. The sensitivity of the refractometer to scattered light is minimized by the special optical design that rejects off-axis light—the less to correct, the better.

It is not known to what extent the label on the vial obscures the view with various vaccine brands. At least some of them have a clear segment on the side of the vial. If the label covers the side surface entirely, measurement from the bottom may have to be considered. Should the vial be misaligned, showing the label to the optics, the condition will be easily detected from the detector signals.

Vaccine Vial Interface: The vial receptacle should accommodate different vial sizes as needed. Since the measurement is done in the vertical plane, vial diameter does not have an effect on the result. (There is a second-order effect on the optics, but it is not expected to be significant, and it is included in the calibration—all the vials tested under that calibration must be of the same size). If necessary, the bottom height of the receptacle could be adjustable. The ambient light should be excluded when the vial is in.

The use of a cover flap is a possibility. It is possible that the modulation of the laser light is sufficient to remove the effect of ambient light.

Electronics: The motherboard carries a processor and enough memory to store at least 1000 readings (timestamp, refractometer and nephelometer). The device is battery-operated, with a battery capacity adequate for at least 1000 measurements. USB charging is a possibility. The largest consumer of power is the laser, with a current draw of the order of 10 mA. A square-wave modulation at 1 kHz is suggested. The four detector channels should have lock-in amplifiers.

There is an optional wireless module for transmitting results to a local computer or a remote site. This may prove to be useful, as an early warning of a forgery will give the authorities a head-start in tracking down its source. Deviant results may occur for reasons other than forgery; we will have to find ways to deal with that possibility. The display may optionally show the actual refractometer and nephelometer readings, or it may show red/green. An audible signal is a possibility.

Operation: The operation at the vaccination site, or anywhere in the vaccination chain, includes a calibration measurement with a vaccine vial that is known to be good and subsequent testing of any number of vaccine vials against the calibration. If the combined refractometer/nephelometer data deviates from the calibration by more than a preset tolerance, the device sounds an alarm and sends an alert using the optional wireless module. Calibration values are retained until a new calibration is done.

This invention measures refractive index and cloudiness of liquids through glass. Vaccine components such as sucrose and PEG affect the refractive index. Each vaccine has its characteristic cloudiness, some are clear. This invention detects aberrant values that indicate a forgery. The device measures one vaccine vial at a time. One vial, known to be authentic, is chosen as calibration, and all other vials will be compared to it. The vial is inserted. For the calibration vial, the Calibration button is pressed. For all others, the device will signal any significant deviation in refractive index or cloudiness. No need to open the vial.

Fast measurement: Because of the fast measurement, all vials in a batch can be tested. No need to rely on statistical estimates. Option of wireless transmission of data cab allow instantaneous alert. The invention is easy to use, at any vaccination site, the invention can be used. The invention can be used on vaccines other than COVID-19. The invention provides it life saving function at very low cost.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A system for validating the identity of the liquid contents of a transparent container, comprising:
a.) an optical device adapted to measure an optical property of the liquid contents of the transparent container, without physical invasion of the container, and without removing the liquid from the container, to provide a value for the optical property; and
b.) a comparator that compares the optical property to a standard value, to validate the identity of the liquid contents of the transparent container.

2. A system as recited in claim 1, wherein the optical property is selected for a group comprising refractive index, turbidity, and combinations thereof.

3. A system as recited in claim 1, wherein the optical property is determined by shining a beam of light through the wall of the container, without physically invading the container, and observing the reflection of the beam.

4. A system as recited in claim 1, wherein the optical property is determined by shining a beam of light through the wall of the container, without physically invading the container, and observing the reflection of the beam, and thereby determining the index of refraction of the liquid.

5. A system as recited in claim 1, wherein the optical property is determined by shining a beam of light through the wall of the container, without physically invading the container, and observing the reflection of the beam, and shining another beam of light through the wall of the container, without physically invading the container, and observing the reflection of the beam to determine turbidity of the liquid, and using the value of the turbidity to correct the determined index of refraction, thereby determining the index of refraction of the liquid.

6. A system as recited in claim 1, wherein the optical property is determined by shining two separate beams of light through the wall of the container, without physically invading the container, and observing the reflection of the beams to determine the index of refraction of the liquid.

7. A system as recited in claim 1, wherein the optical property is determined by shining two separate beams of light through the wall of the container, without physically invading the container, and observing the reflection of the beams to determine the index of refraction of the liquid, and shining another beam of light through the wall of the container, without physically invading the container, and observing the reflection of the beam to determine turbidity of the liquid, and using the value of the turbidity to correct the determined index of refraction, thereby determining the index of refraction of the liquid.

8. A system as recited in claim 1, wherein the liquid is selected from a group comprising vaccine, anti-viral vaccine, and COVID-19 vaccine, and combinations thereof.

9. A system as recited in claim 1, wherein the optical property is determined by shining a beam of light through the wall of the container, without physically invading the container, and using the technology described in a group comprising U.S. Pat. Nos. 10,139,340, 10,234,386, and combinations thereof.

10. A system as recited in claim 1, wherein the optical property is determined by shining a beams of light through the wall of the container, without physically invading the container, and determining the index of refraction, using a device selected for the group comprising a refractometer, a nephelometer, and combinations thereof

11. A method of validating the identity of the liquid contents of a transparent container, comprising the steps of:
determining an optical property of the contents of a container of known content without physically invading the container and without removing the contents from the container,
determining an optical property of the contents of a container of unknown content without physically invading the container, and without removing the contents from the container, and
comparing the optical property of the contents of a container of known content, with optical property of the contents of a container of unknown content.

12. A system as recited in claim 11, wherein the optical property is selected for a group comprising refractive index, turbidity, and combinations thereof.

13. A system as recited in claim 11, wherein the optical property is determined by shining a beam of light through the wall of the container, without physically invading the container, and observing the reflection of the beam.

14. A system as recited in claim 11, wherein the optical property is determined by shining a beam of light through the wall of the container, without physically invading the container, and observing the reflection of the beam, and thereby determining the index of refraction of the liquid.

15. A system as recited in claim 11, wherein the optical property is determined by shining a beam of light through the wall of the container, without physically invading the container, and observing the reflection of the beam, and shining another beam of light through the wall of the container, without physically invading the container, and observing the reflection of the beam to determine turbidity of the liquid, and using the value of the turbidity to correct the determined index of refraction, thereby determining the index of refraction of the liquid.

16. A system as recited in claim 11, wherein the optical property is determined by shining two separate beams of light through the wall of the container, without physically invading the container, and observing the reflection of the beams to determine the index of refraction of the liquid.

17. A system as recited in claim 11, wherein the optical property is determined by shining two separate beams of light through the wall of the container, without physically invading the container, and observing the reflection of the beams to determine the index of refraction of the liquid, and shining another beam of light through the wall of the container, without physically invading the container, and observing the reflection of the beam to determine turbidity of the liquid, and using the value of the turbidity to correct the determined index of refraction, thereby determining the index of refraction of the liquid.

18. A system as recited in claim 11, wherein the liquid is selected from a group comprising vaccine, anti-viral vaccine, and COVID-19 vaccine, and combinations thereof.

19. A system as recited in claim 11, wherein the optical property is determined by shining a beam of light through the wall of the container, without physically invading the container, and using the technology described in a group comprising U.S. Pat. Nos. 10,139,340, 10,234,386, and combinations thereof.

20. A system as recited in claim 11, wherein the optical property is determined by shining a beams of light through the wall of the container, without physically invading the container, and determining the index of refraction, using a device selected for the group comprising a refractometer, a nephelometer, and combinations thereof.
